(19) United States
(12) Patent Application Publication
(10) Pub. No.: US 2005/0053305 A1
(43) Pub. Date: Mar. 10, 2005

(54) Systems and methods for implementing a speckle reduction filter

(76) Inventors: Yadong Li, Waukesha, WI (US); Michael Joseph Washburn, Brookfield, WI (US); Xiaohui Hao, Waukesha, WI (US)

Correspondence Address: Dean D. Small;Armstrong Teasdale LLP, Suite 2600, One Metropolitan Square, St. Louis, MO, 63102, US

(21) Appl. No.: 10/659,184

(22) Filed: Sep. 10, 2003

(51) Int. Cl. G06K 9/40

(52) U.S. Cl. 382/260

(57) ABSTRACT

A method for implementing a speckle reduction filter are described. The method includes receiving a processed data stream from a processor, dividing the processed data stream into data subsets, simultaneously filtering the data subsets by using a speckle reduction filter to produce filtered data subsets, and producing an image data stream based on the filtered data subsets.

### BACKGROUND OF THE INVENTION

This invention relates generally to filtering in imaging systems and particularly to systems and methods for implementing a speckle reduction filter.

Ultrasound imaging is a technique for imaging organs and soft tissues in a human body. Ultrasound imaging uses a real time, noninvasive, nonradiation, portable and a low-cost technique. However, a disadvantage of ultrasound imaging is speckle noise. Speckle noise is a result of interference of scattered echo signals reflected from an object, such as an organ, and appears as a granular grayscale pattern on an image. The speckle noise degrades image quality and increases the difficulty in discriminating fine details in images during diagnostic examinations.

A speckle reduction filter is used to reduce speckle noise. The speckle reduction filter usually does not create motion artifacts, preserves acoustic shadowing, and enhancement. However, the speckle reduction filter may cause a loss of spatial resolution and reduce processing power of an ultrasound imaging system.

### BRIEF DESCRIPTION OF THE INVENTION

In one aspect, a method for implementing a speckle reduction filter are described. The method includes receiving a processed data stream from a processor, dividing the processed data stream into data subsets, simultaneously filtering the data subsets by using a speckle reduction filter to produce filtered data subsets, and producing an image data stream based on the filtered data subsets.

In another aspect, a method for implementing a speckle reduction filter is described. The method includes receiving beams from a beamformer, frequency compounding the beams to obtain a filtered image data stream, receiving a processed data stream from a processor, dividing the processed data stream into data subsets, simultaneously filtering the data subsets by using a speckle reduction filter to produce filtered data subsets, producing a second image data stream based on the filtered data subsets, and simultaneously co-displaying a filtered image and a second image on a common screen, wherein the filtered image is generated from the filtered image data stream and the second image is generated from the second image data stream.

In yet another aspect, a computer-readable medium encoded with a program is described. The program is configured to receive a processed data stream from a processor, divide the processed data stream into data subsets, simultaneously filter the data subsets by using a speckle reduction filter to produce filtered data subsets, and produce an image data stream based on the filtered data subsets.

In still another aspect, a computer is described. The computer is programmed to receive a processed data stream from a processor, divide the processed data stream into data subsets, simultaneously filter the data subsets by using a speckle reduction filter to produce filtered data subsets, and produce an image data stream based on the filtered data subsets.

In another aspect, an ultrasound imaging system is described. The ultrasound imaging system includes a transducer array, a beamformer, a processor for processing a receive beam from the beamformer, and a scan converter and display controller operationally coupled to the transducer array, the beamformer, and the processor. The scan converter and display controller is configured to receive a processed data stream from the processor, divide the processed data stream into data subsets, simultaneously filter the data subsets by using a speckle reduction filter to produce filtered data subsets, and produce an image data stream based on the filtered data subsets.

### BRIEF DESCRIPTION OF THE DRAWINGS

FIG. 1 is an embodiment of an ultrasound imaging system in which systems and methods for implementing a speckle reduction filter are implemented.

FIG. 2 shows an embodiment of a transducer array and a beamformer of the ultrasound imaging system.

FIG. 3 shows a concept of a sector scan that is performed using the ultrasound imaging system.

FIG. 4 shows a concept of a linear scan that is performed using the ultrasound imaging system.

FIG. 5 shows a concept of a convex scan that is performed using the ultrasound imaging system.

FIG. 6 shows an embodiment of a scan converter and display controller of the ultrasound imaging system.

FIGS. 7 and 8 show a flowchart of an embodiment of a method for implementing a speckle reduction filter.

FIG. 9 shows an embodiment of a graphical user interface that displays an image on which the methods and spatial compounding are not applied and displays another image on which the methods are applied in conjunction with spatial compounding.

FIG. 10 shows an embodiment of a graphical user interface that enables a user to select various levels of a combination of detail and smoothness that is provided by a speckle reduction filter implemented in the ultrasound imaging system.

FIG. 11 shows another embodiment of the graphical user interface of FIG. 10.

### DETAILED DESCRIPTION OF THE INVENTION

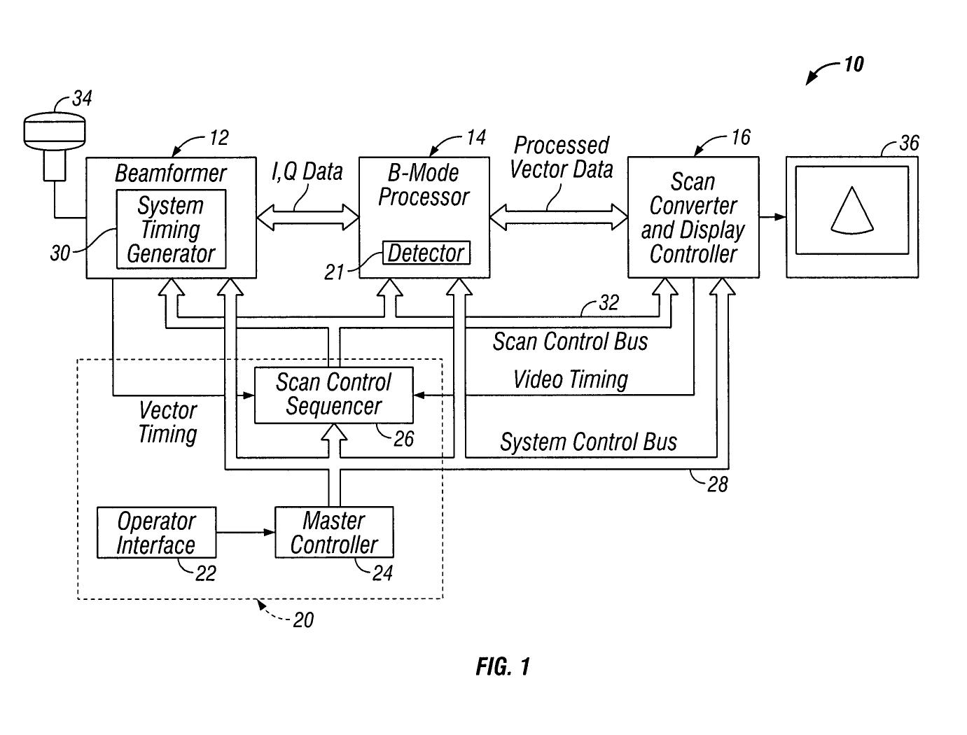

FIG. 1 is an embodiment of an ultrasound imaging system 10 in which systems and methods for implementing a speckle reduction filter are implemented. System includes a beamformer 12, a B-mode processor 14, a scan converter and display controller (SCDC) 16 and a kernel 20. B-mode processor includes a detector 21. Kernel 20 includes an operator interface 22, a master controller 24, and a scan control sequencer 26. Master controller 24 performs system level control functions. Master controller 24 accepts inputs from an operator via operator interface 22 as well as system status changes and makes appropriate changes to beamformer 12, B-mode processor 14, SCDC 16, and scan control sequencer 26. A system control bus 28 provides an interface from master controller 24 to beamformer 12, B-mode processor 14, SCDC 16, and scan control sequencer 26. Scan control sequencer 26 provides real-time control inputs, which are inputs at an acoustic vector rate, to beamformer 12, a system timing generator 30, B-mode processor 14, and SCDC 16. Scan control sequencer 26 is programmed by master controller 24 with vector sequences and synchronization options for acoustic frame acquisitions. Scan control sequencer 26 broadcasts vector parameters that are defined by the operator to beamformer 12, B-mode processor 14, and SCDC 16 via scan control bus 32.

A main data path begins with analog radio frequency (RF) echo signal inputs to beamformer 12 from a transducer array 34. Beamformer 12 converts the analog echo signals into a stream of digital samples and outputs receive beams, which are shown as complex I,Q data, but in general, can also be RF or intermediate frequency data. The I,Q data is input to B-mode processor 14. B-mode processor 14 logarithmically amplifies the I,Q data and detects envelope of the I,Q data. B-mode processor 14 outputs the I,Q data as processed vector image data to SCDC 16. SCDC 16 accepts the processed vector image data and instructs a display device 36 to display an image on a screen of display device 36. An example of the image that is displayed includes a 2-dimensional (2D) image that distinguishes various portions of the object based on the brightness of pixels of the 2D image. Examples of display device 36 includes a grey-scale monitor and a color monitor.

In an alternative embodiment, ultrasound imaging system 10 scans in various scan modes such as a fundamental mode, a harmonic mode, a color flow mode, a PDI mode, a contrast mode, or a B-flow mode. In the fundamental mode, images are generated from echo signals at fundamental frequencies and in the harmonic mode, images are generated from echo signals at harmonic frequencies. In the color flow mode, a Doppler processor (not shown) is used in parallel to or replaces B-mode processor 14. The I,Q data is provided to the Doppler processor to extract Doppler frequency shift information for color flow mode. The Doppler processor estimates Doppler parameters, such as, velocity, variance and power for estimating motion of flow of blood inside the object. The Doppler parameters are estimated using processes such as auto-correlation or cross-correlation. In the PDI mode, power is used to estimate motion of flow of blood inside the object. In the contrast mode, a contrast agent that usually includes an air bubble is used to improve contrast between signals from different anatomical structures, such as, a tumor and a normal liver. The B-flow mode represents the flow of blood inside the object. The flow appears as changes in a speckled pattern.

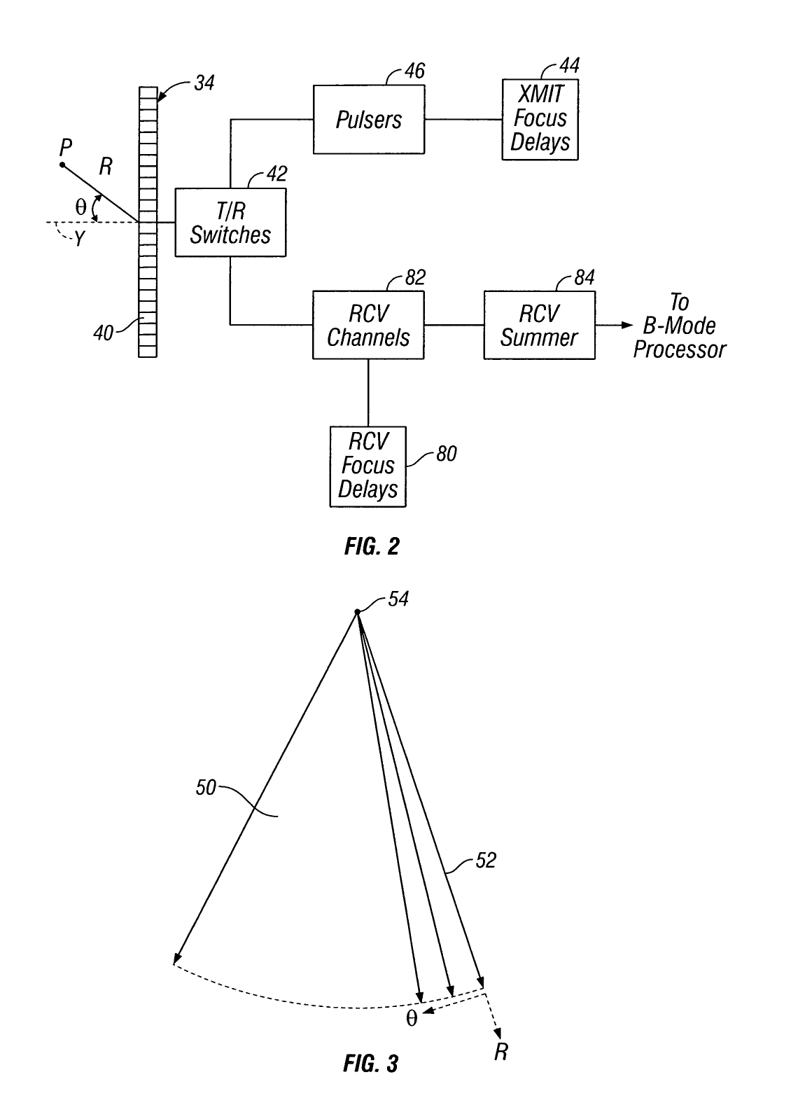

FIG. 2 shows an embodiment of transducer array 20 and beamformer 12 of ultrasound imaging system 10. Transducer array 20 includes a plurality of separately driven transducer elements 40, each of which produces a burst of ultrasonic energy when energized by a pulsed waveform produced by beamformer 12. The ultrasonic energy reflected back to transducer array 34 from the object under study is converted to an electrical signal by each receiving transducer element 40 and applied separately to beamformer 12 through a set of transmit/receive (T/R) switches 42. T/R switches 42 are typically diodes which protect beamformer 12 from high voltages generated by beamformer 12 to obtain ultrasonic energy that is reflected from the object.

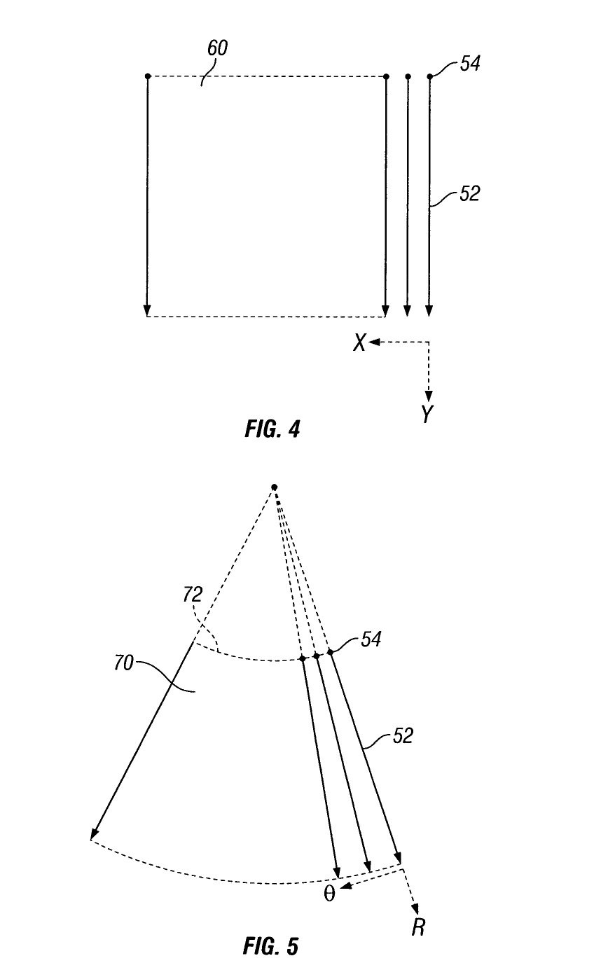

Transducer elements 40 are driven such that the ultrasonic energy produced is directed, or steered, in a beam. To accomplish this, respective transmit focus time delays 44 are imparted to a multiplicity of pulsers 46. Each pulser 46 is connected to a respective transducer element 40 via T/R switches 42. As an example, transmit focus time delays 44 are read from a look-up table. By appropriately adjusting transmit focus time delays 44, the steered beam can be directed away from a y-axis by an angle θ or focused at a fixed range R on a point P. A sector scan, shown in FIG. 3, is performed by scanning a fan-shaped two-dimensional (2D) region 50 along a direction of the angle θ and along an acoustic line 52 extending from an emission point 54. Alternatively, a linear scan, shown in FIG. 4, is performed by scanning a rectangular 2D region 60 in a direction along an x-axis. Rectangular region 60 is scanned in the direction along the x-axis by translating acoustic line 52, which travels from emission point 54 in a direction along the y-axis. In yet another alternative embodiment, a convex scan or a curved linear scan is performed by scanning a partial fan-shaped region 70 in the direction of the angle θ. Partial fan-shaped region 70 is scanned in the direction of the angle θ by performing an acoustic line scan similar to the linear scan and moving emission point 54 of acoustic line 52 along an arc-shaped trajectory 72.

Referring to FIG. 2, echo signals are produced by each burst of ultrasonic energy reflected from objects located at successive ranges along the steered beam. The echo signals are sensed separately by each transducer element 40 and a sample of the magnitude of the echo signals at a particular point in time represents the amount of reflection occurring at a specific range. Due to the differences in the propagation paths between the reflecting point P and each transducer element 40, however, the echo signals will not be detected simultaneously and their amplitudes will not be equal. Beamformer 12 imparts a proper time delay to each echo signal that is reflected from the point P and sums them to provide a single echo signal which accurately indicates the total ultrasonic energy reflected from the point P. Beamformer 12 imparts a proper time delay to each echo signal by imparting respective receive focus time delays 80 to a multiplicity of receive channels 82. Each receive channel 82 is connected to a respective transducer element 40 via a T/R switch 42. As an example, receive focus time delays 80 are read from a look-up table. The time-delayed echo signals are summed in a receive summer 84. A detailed description of a receive section of beamformer 12 is provided in U.S. Pat. No. 5,961,461.

Detector 21, incorporated in B-mode processor 14, receives beams from beamformer 12. I and Q values of the beams represent in-phase and quadrature components of a magnitude of echo signals reflected from the point P at the range R and the angle θ. Detector 21 computes the magnitude (I²+Q²)^{1/2}. In an alternative embodiment, multiple filters and detectors replace detector 21 so that beams received by the filters and detectors are separated into multiple passbands, individually detected and recombined to reduce speckle by frequency compounding.

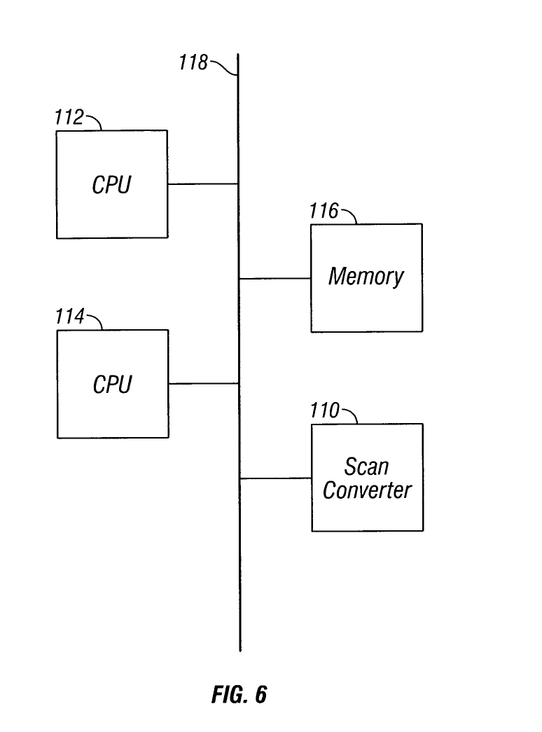

SCDC 16 receives the processed vector image data from B-mode processor 14 and converts the processed vector image data into an image for display. In particular, a scan converter 110, shown in FIG. 6, converts the processed vector image data from a polar coordinate format to a cartesian coordinate format and displays the processed vector image data as an image on display device 36 which images a time-varying amplitude of the processed vector image data. Alternatively if the processed vector image data is in a cartesian coordinate format, SCDC 16 scales the processed vector image data and displays the processed vector image data.

FIG. 6 shows an embodiment of SCDC 16 of ultrasound imaging system 10. SCDC 16 includes central processing units (CPUs) 112 and 114, a memory 116 and scan converter 110. CPUs 112 and 114, memory 116 and scan converter 110 are coupled to each other via a bus 118. CPU, as used herein, is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein. An example of each CPU 112 and 114 includes a CPU, such as Intel® Pentium 4 processors. Examples of memory 116 include a computer-readable medium such as a hard disk, a CD-ROM, or a floppy disk. In an alternative embodiment, SCDC 16 includes one CPU or more than two CPUs. Memory 116 stores programs executed by CPUs 112 and 114. Memory 116 also stores several kinds of data for use by CPUs 112 and 114 in executing the programs.

A speckle reduction filter (not shown), such as a low pass filter, is implemented between detector 21 and SCDC 16 to reduce speckle noise in an image generated using ultrasound imaging system 10. An example of a low pass filter is a finite impulse response (FIR) filter. In an alternative embodiment, the speckle reduction filter is a mathematical algorithm that is executed by any one of CPUs 112 and 114 and that is used on a single image frame to identify and reduce speckle noise content. In yet another embodiment, the speckle reduction filter is a median filter, a Wiener filter, an anisotropic diffusion filter, or a wavelet transformation filter, which are mathematical algorithms executed by one of CPUs 112 and 114. In still another alternative embodiment, the speckle reduction filter is a high pass filter that performs structural and feature enhancement. An example of a high pass filter is an infinite impulse response (IIR) filter. In the median filter, a pixel value of an image generated using ultrasound imaging system 10 is replaced by a median value of neighboring pixels. The Wiener filter can be implemented using a least mean square (LMS) algorithm. The anisotropic diffusion filter uses heat diffusion equation and finite elements schemes. The wavelet transformation filter decomposes echo signals into a wavelet domain and obtained wavelet coefficients are soft-thresholded. In the soft-thresholding, wavelets with absolute values below a certain threshold are replaced by zero, while those above the threshold are modified by shrinking them towards zero. A modification of the soft thresholding is to apply nonlinear soft thresholding within finer levels of scales to suppress speckle noise.

Speckle noise is an intrinsic property of ultrasound imaging, the existence of speckle noise in ultrasound imaging reduces image contrast and resolution. Thus, it is desirable to find ways to reduce the level of speckle noise in ultrasound imaging. Compounding is a technique for speckle noise reduction that can be used in conjunction with speckle reduction filtering. Compounding includes spatial compounding and frequency compounding. Frequency compounding and spatial compounding, which are described below, have been explored as ways to reduce the speckle noise. However, frequency and spatial compounding have limitations of slower frame rate, motion artifacts, or reduced resolutions. Image processing filters are alternatives to compounding. The image processing filters operate on image data instead of front-end acquisitions, and they usually do not have problems, such as loss of frame rate or loss of acoustic shadow, associated with compounding.

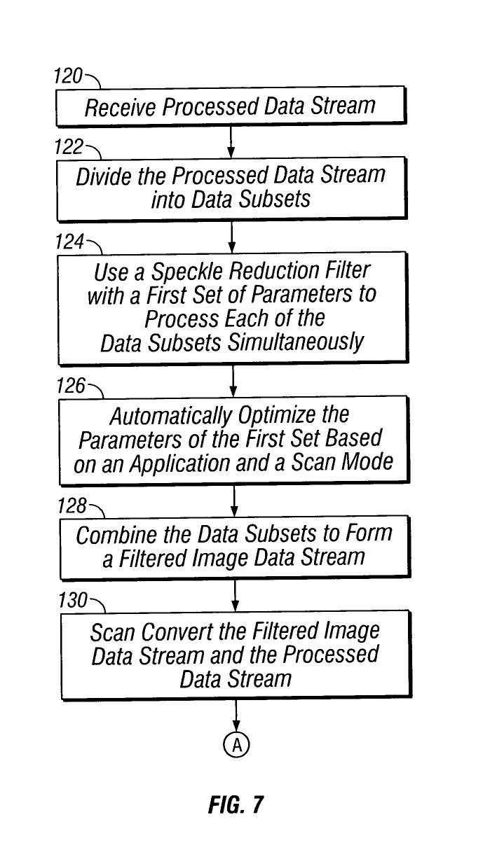

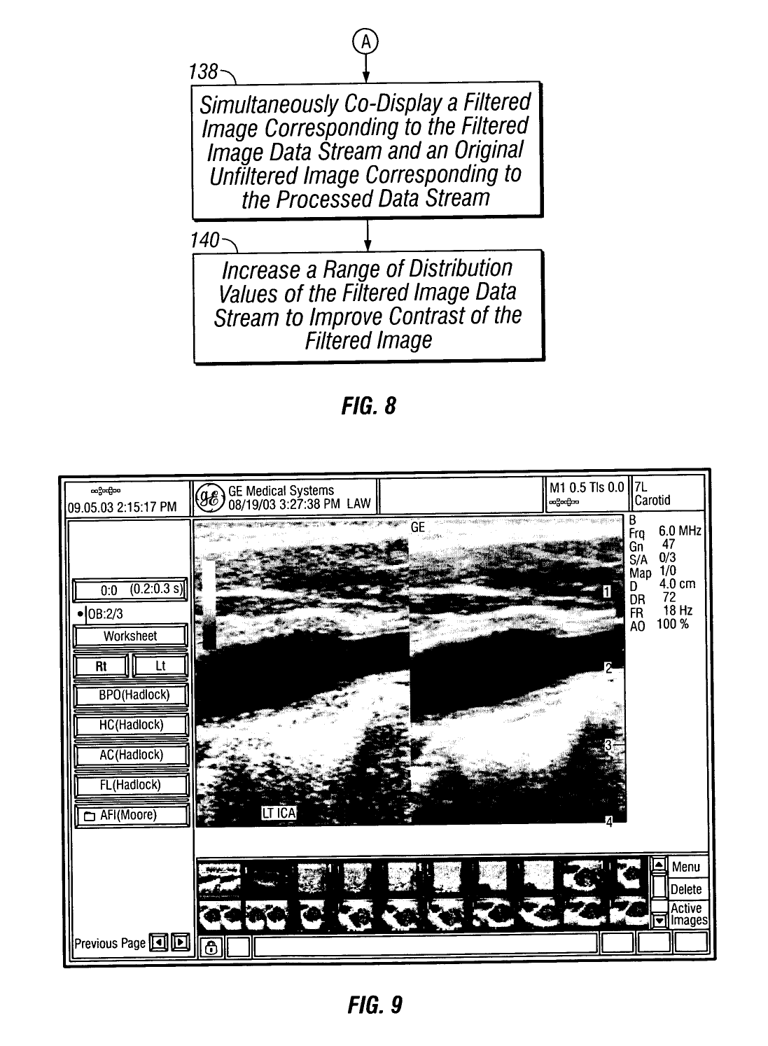

FIGS. 7 and 8 show a flowchart of an embodiment of a method for implementing a speckle reduction filter. The method is stored in memory 116 and is executed by one or both CPUs 112 and 114. The method in step 120 includes receiving a processed data stream, an example of which is the processed vector image data, from B-mode processor 14. Alternatively, a data stream is received from the Doppler processor instead of B-mode processor. In yet another alternative embodiment, a data stream is received from both the Doppler processor and B-mode processor 14. Frequency compounding or spatial compounding of beams is performed in B-mode processor 14 before obtaining the processed data stream from B-mode processor 14. Spatial compounding is an imaging technique in which a number of echo signals of the point P that have been obtained from a number of multiple look directions or angles are combined. The multiple directions help achieve speckle decorrelation. For the frequency compounding, speckle decorrelation is achieved by imaging the point P with different frequency ranges. The frequency compounding is performed in B-mode processor 14 or the Doppler processor. Similarly, the spatial compounding is performed in B-mode processor 14 or the Doppler processor. By combining spatial compounding with the methods for implementing a speckle reduction filter, the number of angles can be reduced, for instance, from 9 to 3, to reduce motion artifacts while maintaining a level of speckle noise reduction. However, alternatively, the spatial or the frequency compounding may not be performed.

The method in step 122 includes dividing the processed data stream into data subsets. As an example, data corresponding to an image frame is divided into data subsets so that a data subset corresponds to a portion of the image frame. The method in step 124 includes using a speckle reduction filter with a first set of parameters, such as smoothness and detail, to filter each of the data subsets simultaneously. For instance, a first data subset is processed by a speckle reduction filter that is executed by CPU 112 and a second data subset is processed simultaneously with the first data subset by a speckle reduction filter that is executed by CPU 114. As another instance, first data subset and the second data subset are processed simultaneously by a speckle reduction filter that is executed by CPU 112 by using the SIMD capability. A set of controls, such as buttons or menus, are provided to a user to adjust the first set of parameters of the speckle reduction filter. The first set of parameters can be adjusted by the user when a scan is being performed with ultrasound imaging system 10, a replay of recorded scans is being displayed on the screen of display device 36, or a still image is being displayed on the screen of display device 36.

Moreover, the method in step 126 includes automatically, without user intervention, optimizing the parameters of the first set based on an application and a scan mode of ultrasound imaging system 10. For example, the method may refer to a mapping table that provides various sets of parameters of the speckle reduction filter based on the application and the scan modes. In the example, an image of a liver is filled with more speckle noises than speckle noises in vascular images. Therefore, in the example, the mapping table maps to parameters providing greater smoothness than the amount of smoothness provided to vascular images. Examples of the application includes whether ultrasound imaging system 10 is used to obtain images of a liver or vascular images. Examples of the scan mode include modes in which the sector scan, the linear scan, and the convex scan, which are described above, are performed. In an alternative embodiment, the method may not perform the step 126. The method in step 128 includes combining the data subsets that are filtered to form a filtered image data stream. As an example, the data subsets can be combined to form an image data stream of an image frame. Common data in any two data subsets is removed while combining the data subsets to form the filtered image data stream. Such common data is displayed as a common border area in an image. Removing at least a portion of the common data eliminates any visible border lines in an image corresponding to the two data subsets and makes the border area smooth. The method in step 130 further includes using scan converter 110 to scan convert a data set that includes the filtered image data stream and the processed data stream output from B-mode processor 14. Alternatively, the method includes scan converting a data set that includes the filtered image data stream and a data stream output from the Doppler processor. In yet another alternative embodiment, the method includes scan converting a data set that includes the filtered image data stream, a data stream output from the Doppler processor, and the processed data stream from B-mode processor 14.

In an alternative embodiment, the step 130 can be performed before performing steps 122, 124, 126, and 128, and after performing the step 120. In the alternative embodiment, the processed data stream is scan converted before dividing the processed data stream into the data subsets. An image that is reconstructed from the filtered image data stream and an image reconstructed from the processed and scan converted data stream are simultaneously co-displayed on the screen of display device 36.

The method in step 138 includes simultaneously co-displaying a filtered image and an original unfiltered image on the screen of display device for real time viewing of the filtered image and the original unfiltered image in a dual display mode. The original unfiltered image bypasses the speckle reduction filtering stage. The filtered image and the original unfiltered image are simultaneously co-displayed by fitting the original unfiltered image reconstructed from the processed and scan converted data stream with the filtered image reconstructed from the filtered and scan converted data stream on one common screen of display device 36. As an example, the original unfiltered image is displayed on half of the area of the screen of display device 36 and the filtered image is displayed on the remaining half of the area of the screen. As another example, the original unfiltered image is displayed on a third of the area of the screen of display device 36 and the filtered image is displayed on the remaining two-thirds area of the screen. As yet another example, the original unfiltered image is unfiltered image of a 4 cm×4 cm tissue area that is simultaneously co-displayed with the filtered image, which can be an image of the tissue area. The filtered image of the tissue area occupies half of the area of the screen of display device 36 and the original unfiltered image occupies the remaining half. The filtered image helps a clinician or a sonographer identify objects having low contrast and tissue structures. The original unfiltered image helps identify artifacts caused by a speckle reduction filter and also provides image details that are lost due to the speckle reduction filter.

In still another alternative embodiment, the filtered image is displayed on one side of the screen of display device 36. On the remaining side of the screen, an image on which a second set of parameters, described below, of the speckle reduction filter are applied instead of the first set of parameters is displayed. In another alternative embodiment, the original unfiltered image, an example of which is shown on the left side in FIG. 9, is displayed on one side of the screen. On the remaining side, such as the right side in FIG. 9, an image to which the methods for implementing a speckle reduction filter and spatial compounding are applied is displayed. In another alternative embodiment, the filtered image is displayed on one side of the screen. On the remaining side, an image to which spatial compounding is applied but a speckle reduction filter is not applied is displayed. In yet another alternative embodiment, the filtered image is displayed on one side of the screen. On the remaining side, an image to which the methods for implementing a speckle reduction filter and spatial compounding, are applied is displayed. In still another alternative embodiment, an image to which spatial compounding is applied but a speckle reduction filter is not applied is displayed on one side of the screen. On the remaining side, an image to which the methods for implementing a speckle reduction filter and spatial compounding are applied is displayed.

In another alternative embodiment, the screen of display device 36 is divided into first, second, third, and fourth areas to display images in a quadrature-display mode. The first area displays the original unfiltered image. The second area displays an image to which spatial compounding is applied but a speckle reduction filter is not applied. The third area displays the filtered image. The fourth area displays an image to which the methods for implementing a speckle reduction filter and spatial compounding are applied. It is noted that in the alternative embodiment, frequency compounding instead of or in addition to spatial compounding can be applied. Moreover, in the alternative embodiment, as an example, each image is displayed in one-fourth of the area of the screen. As another example, an image is displayed in 1/12^{th} the area of the screen, an image is displayed in ⅓^{rd} the area of the screen, an image is displayed in ⅛^{th} the area of the screen, and an image is displayed in ⅛^{th} the area of the screen.

In yet another alternative embodiment, each of the four areas display an image to which different parameters of the speckle reduction filter are applied than those applied to any other image displayed on the remaining areas. Moreover, in the alternative embodiment, the different parameters are applied while executing the methods for implementing a speckle reduction filter. In still another alternative embodiment, the first area displays the original unfiltered image. In the alternative embodiment, each of the remaining three areas display an image to which different parameters of the speckle reduction filter are applied than those applied to any other image displayed on the remaining of the three areas. Moreover, in the alternative embodiment, the different parameters are applied while executing the methods for implementing a speckle reduction filter.

The method in step 140 further includes increasing a range over which values of data included in the filtered image data stream are distributed to improve contrast of the filtered image. The speckle reduction filter usually changes a grayscale distribution of an image and so pixel values of the filtered image has a narrower distribution than that of pixels values of an image that has not been filtered by a speckle reduction filter. The narrower distribution of grayscales can be changed to increase image contrast. As an example, if pixel values of an image frame that has not undergone filtering by a speckle reduction filter range from 0 to 255, after applying the speckle reduction filter, pixel values of an image frame range between 20-230. In the example, the pixel values that range between 20-230 can be increased to 255 pixel values by using a linear function, such as a mapping function. Such an increase improves contrast of an image frame to which a speckle reduction filter is applied.

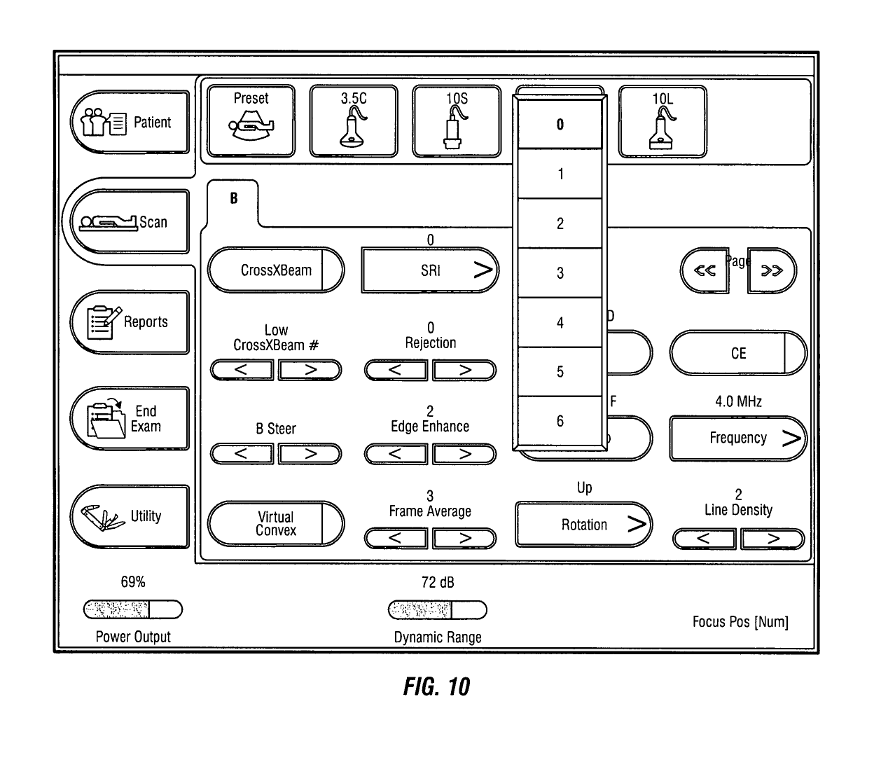

The method includes changing values of the parameters of the first set of the speckle reduction filter to form a second set of parameters. For instance, the level of smoothness provided to an image can be changed from 10 to 20 on a scale of 100. As yet another instance, the level of smoothness provided to an image can be changed from 30 to 20 on a scale of 100. As another instance, the level of detail visible in an image can be changed from 15 to 20 on a scale of 100 so that more detail is visible in an image. Buttons are provided on the screen of display device 36 so that a user changes the parameters from the first set to the second set to obtain desirable effects for an application of ultrasound imaging system 10. As an example, buttons “0-6”, shown in FIG. 10, are provided. In the example, each button corresponds to a level of combination of detail and smoothness provided by a speckle reduction filter. A user can select any of the buttons “0-6” to select a level of the combination of detail and smoothness. After changing the first set of parameters, steps 120, 122, 124, 126, 128, 130, and 138 are recalculated and reapplied with the new set of parameters.

The method also includes enabling a user to enter a dual display mode in which two images are shown simultaneously side-by-side while a scan is being performed with ultrasound imaging system 10, while a replay of pre-recorded cine loops is displayed on the screen of display device 36, or while a still image is being displayed on the screen of display device 36. Alternatively, the method includes enabling a user to exit a dual display mode to perform a scan with ultrasound imaging system 10, to replay pre-recorded cine loops on the screen of display device 36, or to display a still image on the screen of display device 36.

It is noted that the systems and methods for implementing a speckle reduction filter can be used in conjunction with a computer-aided diagnosis (CAD) algorithm. As an example, the CAD algorithm is used to distinguish different organs, such as liver and kidney. As another example, the CAD algorithm is used to distinguish liver cancer from normal tissues of the liver. The CAD algorithm can be implemented for real time imaging or for imaging that is to be performed at a later time. Moreover, it is noted that the systems and methods can be implemented in ultrasound imaging system 10 in which beamformer is a 3D beamformer and in which an image reconstructor is included in SCDC 16. The image reconstructor can be coupled to bus 118 of SCDC 16. Quality and accuracy of 3D rendering, both volume and surface rendering, is improved in each individual 2D frame of ultrasound imaging system 10 that undergoes speckle noise reduction before 3D reconstruction. The methods and systems can be used with ultrasound imaging system 10 to provide better 3D image reconstruction by counteracting drawbacks of the speckle noise. It is also noted that the systems and methods for implementing a speckle reduction filter can be implemented in other imaging modalities such as, for instance, positron emission tomography (PET), single photon emission computed tomography (SPECT), computed tomography (CT), and magnetic resonance imaging (MRI) systems.

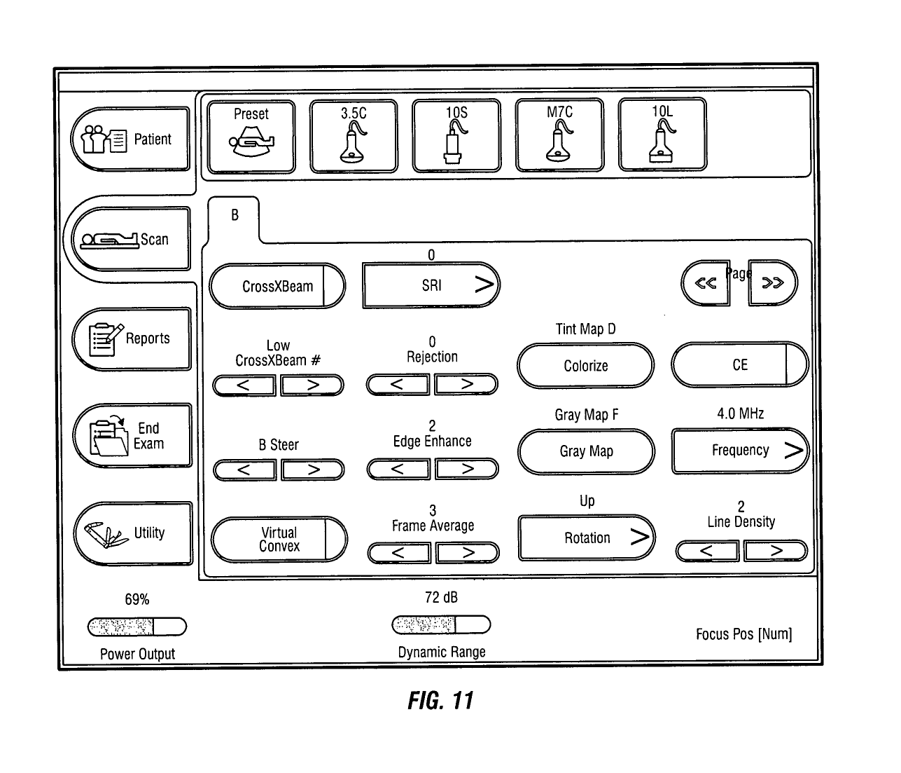

Moreover, it is noted that the herein described methods can be used in combination with frame averaging. In one embodiment, the level of frame averaging can be changed by selecting “>” or “<” buttons shown under a heading “Frame Average” in FIG. 11. Frame averaging can be applied before or after using the speckle reduction filter. In frame averaging, multiple image frames are averaged to produce an image frame. Furthermore, it is noted the systems and methods can be applied to beams output from beamformer 12. It is also noted that although FIGS. 7 and 8 show steps in a consecutive order, in alternative embodiments, the order can change. For example, the step 140 can be performed before step 138 and after step 130.

Additionally, although the herein described methods are described in a medical setting, it is contemplated that the benefits of the methods accrue to non-medical imaging systems such as those systems typically employed in an industrial setting or a transportation setting, such as, for example, but not limited to, a baggage scanning system for an airport, other transportation centers, government buildings, office buildings, and the like. The benefits also accrue to micro PET and CT systems which are sized to study lab animals as opposed to humans.

Technical effects of the systems and methods include improved processing speed, which is suitable for real time implementation. Moreover, the technical effects include the dual display of the filtered image and the original unfiltered image in real time to provide sonographers useful diagnostic information. The sonographers can find features quickly because of improved image contrast of the filtered image and feature enhancement. The sonographers can compare the original unfiltered image and the filtered image to determine whether there are artifacts or loss of details by application of a speckle reduction filter. Additional technical effects of the systems and methods include providing user controls that enables a user to immediately change the parameters of the first set during a live scan, a replay of a cine loop, or a display of a frozen image. The user can adjust the parameters of the first set according to his or her needs.

While the invention has been described in terms of various specific embodiments, those skilled in the art will recognize that the invention can be practiced with modification within the spirit and scope of the claims.

1. A method for implementing a speckle reduction filter comprising:
receiving a processed data stream from a processor;
dividing the processed data stream into data subsets;
simultaneously filtering the data subsets by using a speckle reduction filter to produce filtered data subsets; and
producing an image data stream based on the filtered data subsets.

2. A method in accordance with claim 1 further comprising:
displaying the image data stream as a filtered image on a screen.

3. A method in accordance with claim 1 further comprising:
increasing a range over which values of data included in the image data stream are distributed to improve contrast of a filtered image generated from the image data stream.

4. A method in accordance with claim 1 further comprising:
simultaneously co-displaying a filtered image and an original unfiltered image on a common screen, wherein the filtered image is generated from the image data stream and the original unfiltered image is generated from the processed data stream.

5. A method in accordance with claim 1 further comprising:
using frame averaging in conjunction with the method.

6. A method in accordance with claim 1 wherein the filtering step is based on adjustable parameters, the method further comprising:
changing values of the parameters between first and second value sets to form a first and second image data streams; and
simultaneously co-displaying a first image and a second image on a common screen, wherein the first image is generated from the first image data stream, and wherein the second image is generated from the second image data stream.

7. A method in accordance with claim 1 further comprising:
simultaneously co-displaying, in a dual display mode, a filtered image and an original unfiltered image on a common screen, wherein the filtered and the original unfiltered images are reconstructed from a data set that includes the image data stream and the processed data stream; and
enabling a user to enter the dual display mode during one of a scan, a replay of pre-recorded cine loops, and a display of a still image that is not updated periodically.

8. A method in accordance with claim 1 wherein the filtering step is based on adjustable parameters, the method further comprising:
providing a set of controls to a user to adjust the parameters of the speckle reduction filter.

9. A method in accordance with claim 1 wherein the filtering step is based on adjustable parameters, the method further comprising:
automatically, without user intervention, optimizing the parameters based on an application and a scan of an imaging system.

10. A method in accordance with claim 1 wherein the filtering step is based on adjustable parameters, the method further comprising:
enabling a user to adjust the parameters during one of a scan, a replay of recorded scans, and a display of a still image.

11. A method in accordance with claim 1 wherein any two of the data subsets have common data, the method further comprising:
combining the data subsets to form a filtered image data stream; and
eliminating a portion of the common data present in any two of the data subsets while combining the data subsets to form the filtered image data stream.

12. A method in accordance with claim 1 further comprising:
performing one of frequency compounding and spatial compounding of beams that are a combination of echo signals before receiving the processed data stream.

13. A method in accordance with claim 1 further comprising:
using the method in conjunction with a computer-aided diagnosis (CAD) algorithm.

14. A method for implementing a speckle reduction filter comprising:
receiving beams from a beamformer;
frequency compounding the beams to obtain a filtered image data stream;
receiving a processed data stream from a processor;
dividing the processed data stream into data subsets;
simultaneously filtering the data subsets by using a speckle reduction filter to produce filtered data subsets;
producing a second image data stream based on the filtered data subsets; and
simultaneously co-displaying a filtered image and a second image on a common screen, wherein the filtered image is generated from the filtered image data stream and the second image is generated from the second image data stream.

15. A computer-readable medium encoded with a program configured to:
receive a processed data stream from a processor;
divide the processed data stream into data subsets;
simultaneously filter the data subsets by using a speckle reduction filter to produce filtered data subsets; and
produce an image data stream based on the filtered data subsets.

16. A computer-readable medium in accordance with claim 15 wherein the program is further configured to:
instruct a display device to display the image data stream as a filtered image on a screen.

17. A computer-readable medium in accordance with claim 15 wherein the program is further configured to:
increase a range over which values of data included in the image data stream are distributed to improve contrast of a filtered image generated from the image data stream.

18. A computer-readable medium in accordance with claim 15 wherein the program is further configured to:
simultaneously co-display a filtered image and an original unfiltered image on a common screen, wherein the filtered image is generated from the image data stream and the original unfiltered image is generated from the processed data stream.

19. A computer-readable medium in accordance with claim 15 wherein the program is further configured to:
apply frame averaging in conjunction with the method.

20. A computer programmed to:
receive a processed data stream from a processor;
divide the processed data stream into data subsets;
simultaneously filter the data subsets by using a speckle reduction filter to produce filtered data subsets; and
produce an image data stream based on the filtered data subsets.

21. An ultrasound imaging system comprising:
a transducer array;
a beamformer;
a processor for processing a receive beam from the beamformer;
a scan converter and display controller operationally coupled to the transducer array, the beamformer, and the processor, the scan converter and display controller configured to:
receive a processed data stream from the processor;
divide the processed data stream into data subsets;
simultaneously filter the data subsets by using a speckle reduction filter to produce filtered data subsets; and
produce an image data stream based on the filtered data subsets.

22. An ultrasound imaging system in accordance with claim 21 wherein the scan converter and display controller is further configured to:
simultaneously co-display a filtered image and an original unfiltered image on a common screen, wherein the filtered image is generated from the image data stream and the original unfiltered image is generated from the processed data stream, wherein the filtered image is one of a 2-dimensional and a 3-dimensional image.

23. An ultrasound imaging system in accordance with claim 21 wherein the scan converter and display controller includes more than one central processing unit (CPU), wherein each CPU simultaneously processes a data subset of the image data stream.

24. An ultrasound imaging system in accordance with claim 21 wherein the scan converter and display controller includes a central processing unit (CPU) that simultaneously processes the data subsets of the image data stream.

25. An ultrasound imaging system in accordance with claim 21 wherein the ultrasound imaging system scans in one of a fundamental mode, a harmonic mode, a color flow mode, a power Doppler imaging (PDI) mode, a contrast mode, and a B-flow mode to obtain echo signals reflected from an object under examination.
